(19) United States
(12) Patent Application Publication
(10) Pub. No.: US 2016/0059942 A1
(43) Pub. Date: Mar. 3, 2016

(54) Boat Lift Stabilizer

(71) Applicant: Slidemoor Boat Docking Systems, Naples, FL (US)

(72) Inventors: John T. D'Orazio, Naples, FL (US); James Murphy, Naples, FL (US); Tom Parsons, Stuart, FL (US)

(21) Appl. No.: 14/836,566

(22) Filed: Aug. 26, 2015

Related U.S. Application Data
(60) Provisional application No. 62/041,906, filed on Aug. 26, 2014.

(51) Int. Cl. B63C 3/06; F16M 13/02

(52) U.S. Cl. CPC B63C 3/06; F16M 13/022

(57) ABSTRACT

A boat lift stabilizer includes a carriage, a mounting bracket, and a boat lift bracket. The carriage is engaged with a support element in a slideable configuration. The support element is attached to a structural support member. The mounting bracket is attached to the carriage on one end and attached to the boat lift bracket on an other end, and the boat lift bracket is configured to be attached to a lift. A method for stabilizing a vessel and a system for stabilizing a vessel are also disclosed.

### CROSS-REFERENCE TO RELATED APPLICATION

This application claims priority to a U.S. Provisional Patent Application No. 62/041,906 filed Aug. 26, 2014, the disclosure of which is hereby incorporated by reference in its entirety.

### BACKGROUND OF THE INVENTION

1. Field of the Invention

The present disclosure relates to a lift stabilizing device for use with a boat lift or other type of lift, such as the types of lifts that are commonly used along docks, seawalls, and other bodies of water.

2. Description of the Related Art

Boat lifts are primarily used for the purpose of raising and lowering a vessel into or out of water. It is well-known that long-term contact with water increases the likelihood that the hull of a vessel will be damaged, such as by being affected by aquatic life like algae or other forms of marine bacteria. Also, the corrosive nature of salt water, and extended exposure thereto, may cause significant damage to boat hulls while sitting in the water for long periods of time. Boat lifts not only serve to counteract the damaging impact of marine life on the boat hull but they also serve a number of other useful purposes including those related to storage, maintenance, boarding of people, loading of supplies, etc.

Boat lifts can, for example, be powered manually, electrically, or hydraulically. A commercial example of a cable boat lift is the Golden Boat Lifts GatorVator™, which is described and shown at http://www.goldenboatlifts.com/gatorvator.htm, the contents of which are hearby incorporated by reference in their entirety. The most common type of boat lift is that in which the base frame (otherwise known as a bunk) is suspended by cables. The cables used in connection with these types of boat lifts typically span from 2-20 feet in length and can lift up to tens of thousands of pounds of boats and other vessels or marine products by providing support to the vertical movement of a bunk. The bunk further supports and holds the base of the boat, resulting in the boat's vertical movement in and out of the water, directly corresponding to the cable's upward and downward movement.

One problem associated with boat lifts, especially cable lifts, is lateral movement of the vessel engaged by the boat lift. This lateral movement can be caused by, but not limited to, wind and storms, water movement, people boarding and applying pressure to the vessel or lift, or other forces applied to the vessel or lift. The lateral movement can be as much as a couple feet for some boat lifts. One problem associated with this lateral movement is that it can result in damage to the vessel, such as by hitting pilings or other supports. Further, the lateral movement can be dangerous to people boarding or on the vessel, the swaying causing them to lose balance or even fall overboard. Thus the lateral movement can, therefore, be a threat to passenger safety. Additionally, cable abrasion caused by the lateral movements is a concern. Any wear of the carrying cables due to lateral movement over a period of time can threaten the structural integrity of the boat lift, and ultimately the boat.

### SUMMARY OF THE INVENTION

In one aspect of the invention, a boat lift stabilizer includes a carriage that is engaged with a support element in a slideable configuration for movement along the support element. The support element is attached to a structural support member. The boat lift stabilizer also includes a mounting bracket attached to the carriage on one end. On an other end, the mounting bracket is attached to a boat lift bracket, the boat lift bracket configured to attach to a lift.

In another aspect of the invention, a method for stabilizing a vessel includes providing a boat lift stabilizer. The boat lift stabilizer includes a carriage that is engaged with a support element in a slideable configuration for movement along the support element. The support element is attached to a structural support member. The boat lift stabilizer also includes a mounting bracket attached to the carriage on one end. On an other end, the mounting bracket is attached to a boat lift bracket, the boat lift bracket configured to attach to a lift. The method also includes attaching the boat stabilizer to a lift configured to raise and lower a vessel, such that the boat lift stabilizer prevents or reduces lateral movement of the vessel engaged by the lift.

In another aspect of the invention, a system for stabilizing a vessel includes a lift configured to raise or lower a vessel. The system also includes a boat lift stabilizer that includes a carriage that is engaged with a support element in a slideable configuration for movement along the support element. The support element is attached to a structural support member. The boat lift stabilizer also includes a mounting bracket attached to the carriage on one end. On an other end, the mounting bracket is attached to a boat lift bracket, the boat lift bracket configured to attach to the lift and prevent or reduce lateral movement of the vessel engaged by the lift.

These and other features and characteristics of the present invention, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and the claims, the singular form of “a”, “an”, and “the” include plural referents unless the context clearly dictates otherwise.

### BRIEF DESCRIPTION OF THE DRAWINGS

FIG. 1 shows a perspective view of an aspect of a boat lift stabilizer in its unassembled state.

FIG. 2 shows a perspective view of an aspect of a boat lift stabilizer in its assembled state.

FIG. 3 shows a perspective view of an aspect of a boat lift stabilizer in its unassembled state.

FIG. 4 shows a perspective view of an aspect of a boat lift stabilizer in its assembled state.

FIG. 5 shows a perspective view of an aspect of a boat lift stabilizer in its assembled state.

FIG. 6 shows a top cross-section of one aspect of a boat lift stabilizer.

FIG. 7 shows a top cross-section of one aspect of a boat lift stabilizer.

FIG. 8 shows a perspective view of a boat lift stabilizer attached to a boat lift.

### DETAILED DESCRIPTION OF THE INVENTION

It will be apparent to those skilled in the art that many uses and design variations are possible for the boat lift stabilizer disclosed herein. The following detailed description of various alternative embodiments and preferred aspects will illustrate general principles of the invention, but other aspects and variations will be apparent to those skilled in the art given the benefit of this disclosure.

For purposes of the description hereinafter, the terms “end”, “upper”, “lower”, “right”, “left”, “vertical”, “horizontal”, “top”, “bottom”, “lateral”, “longitudinal” and derivatives thereof shall relate to the invention as it is oriented in the drawing figures. However, it is to be understood that the invention may assume various alternative variations and step sequences, except where expressly specified to the contrary. It is also to be understood that the specific devices and processes illustrated in the attached drawings, and described in the following specification, are simply exemplary embodiments of the invention. Hence, specific dimensions and other physical characteristics related to the embodiments disclosed herein are not to be considered as limiting.

As used herein, lateral movement refers to movement of the boat and/or boat lift substantially perpendicular to the vertical direction, such as, for example, movement taking place in the port (left side), starboard (right side), bow (front), and stern (back) directions of the boat. Substantially perpendicular means movement that may include some vertical component due to variability in the specific boat lift systems/stabilizers employed.

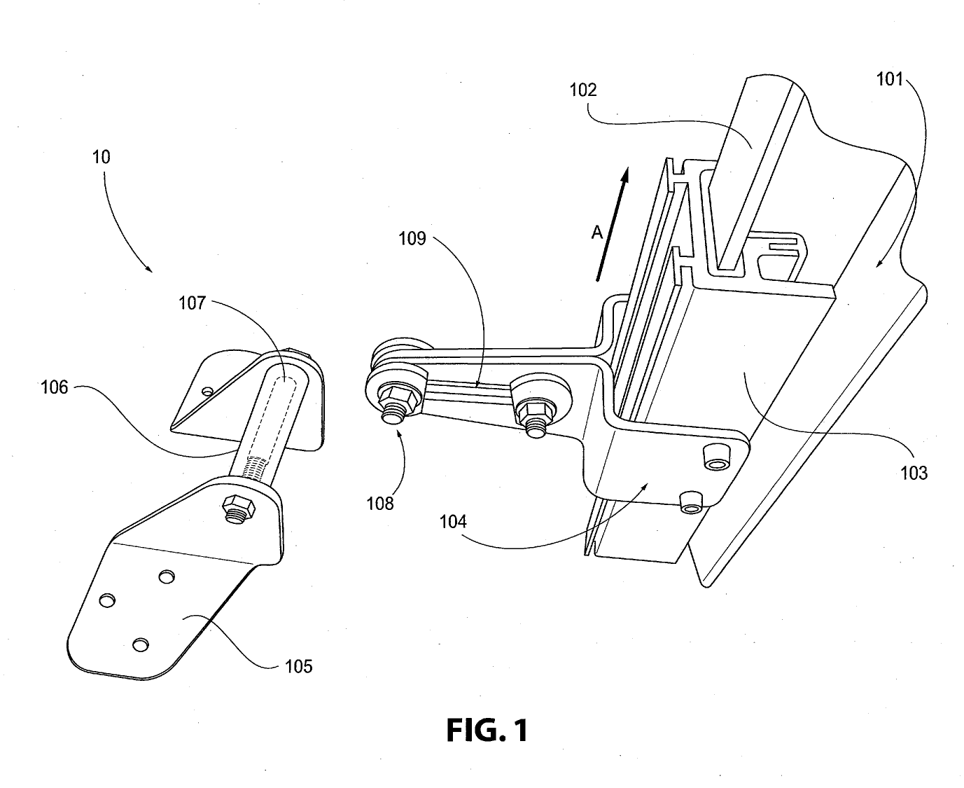

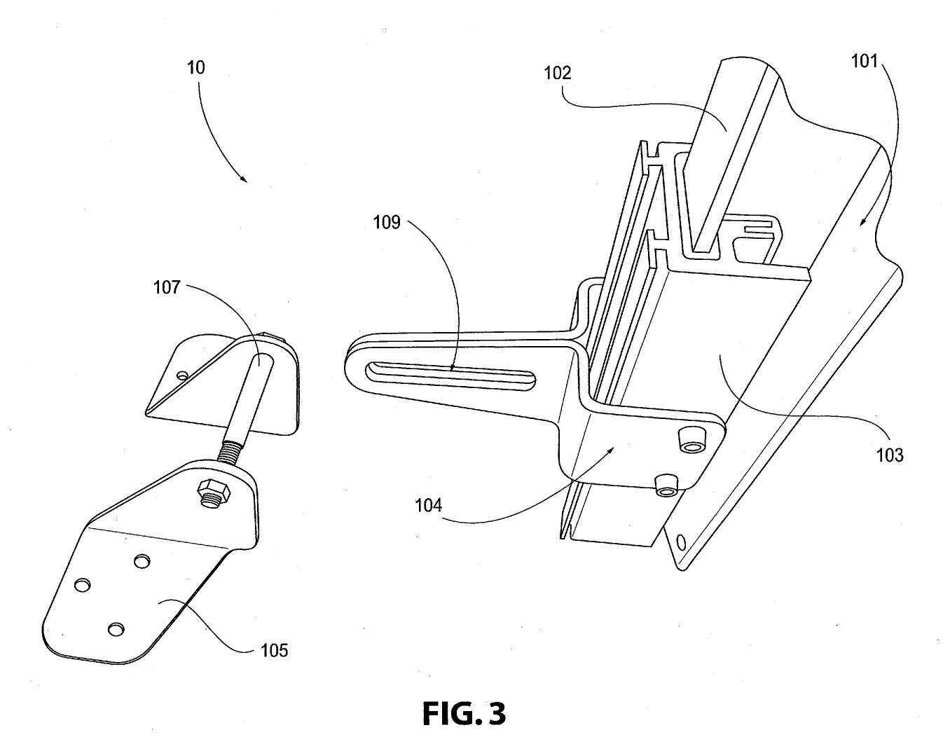

Referring to FIGS. 1-8, in some aspects, a boat lift stabilizer 10 may include a structural support member 101, a support element 102, a carriage 103, a mounting bracket 104, a boat lift bracket 105, a spacer element 106, a boat lift pin 107, bolt-nut-washer assemblies 108, and at least one through-hole 109. The boat lift stabilizer 10 attaches to a lift 111.

The structural support member 101 is a fixed structure that supports the support element 102. In some aspects of the invention, the structural support member 101 extends through the water and penetrates the marine floor. By way of example, the structural support member 101 may be a wood piling, concrete piling, I-Beam, seawall, etc. In other aspects, the structural support member is also embedded or further supported by another structure such as a mountainside, concrete wall, rock bed, or any other type of support structure.

The support element 102 attaches to the carriage 103 and allows the carriage 103 to move freely up and down in a slideable configuration along the support element 102. In some aspects of the invention, the support element 102 is an I-Beam. However, in other aspects, the support element 102 is a Y-Beam, circular beam, or other similar member. The support element 102 is attached to the structural support member 101, which supports the support element 102 and reduces the potential for vessel movement in a lateral direction.

The carriage 103 is attached to the support element 102 and is configured to freely move up and down the support element 102, such as by sliding. The carriage 103 slides up the support element 102 in the direction of arrow A (in the vertical direction) of FIG. 1, and also slides down the support element 102 in the opposite direction of arrow A.

In one aspect of the invention, the structural support member 101, the support element 102, and the carriage 103 are manufactured from 6061-T6 extruded aluminum for strength and high resistance to corrosion, but any suitable material may be used. In one aspect of the invention, to form the slideable configuration between the support element 102 and the carriage 103, a bearing lines the interior surfaces of the carriage 103, which may be made from ⅛ inch extruded Carilon®. This arrangement allows for frictionless or low friction movement and high lubricity for the carriage's smooth travel along the support element 102. However, any other suitable means of creating a sliding arrangement between the support element 102 and the carriage 103, such as by rolling bearing(s) or wheel(s), or by frictionless or low friction surfaces or lubricants, is contemplated by the present disclosure.

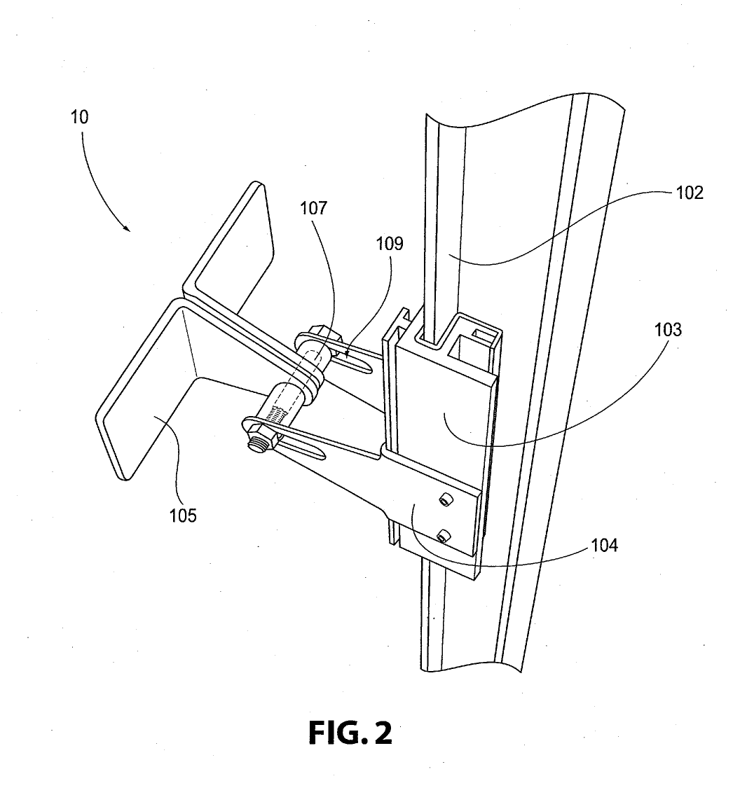

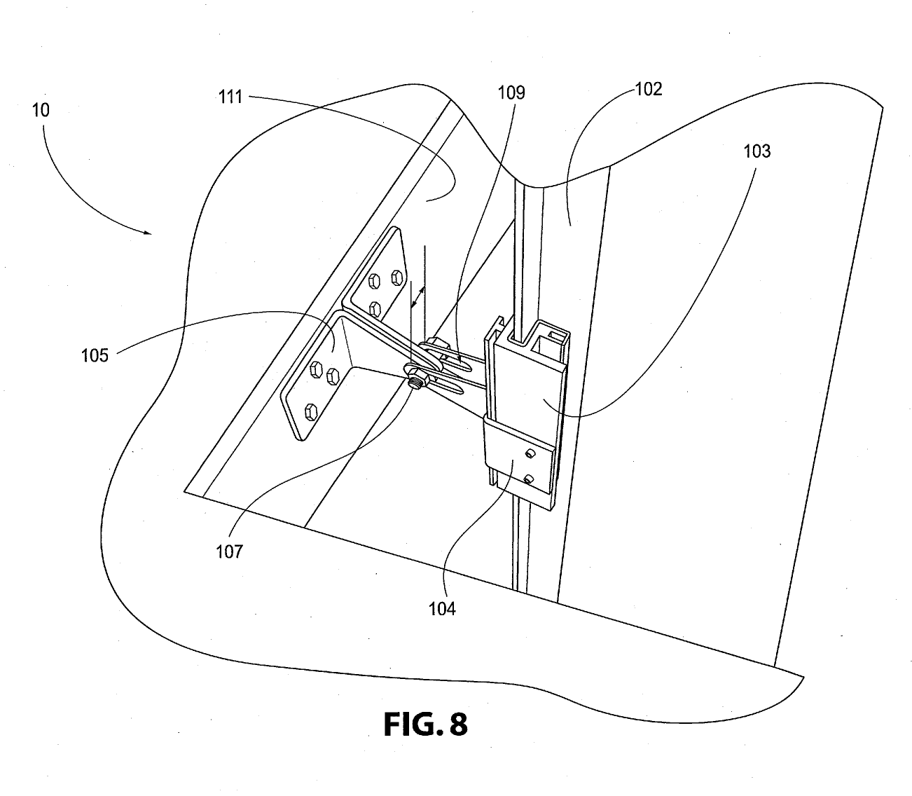

The mounting bracket 104 is attached to the carriage 103 and is used to attach the boat lift bracket 105 to the carriage 103. The mounting bracket 104 includes a right half and a left half. In one aspect of the invention, shown in FIGS. 1, 3, and 5, the right half and left half of the mounting bracket 104 are each attached to the carriage 103 on one end by any means of attaching, such as by screws or bolts. The other end of the right half and left half of the mounting bracket 104 are in physical contact or nearly in physical contact with one another, to form a Y-shaped mounting bracket 104 (see FIG. 1). In another aspect of the invention, shown in FIGS. 2 and 8, the right half and left half of the mounting bracket 104 are each attached to the carriage 103 on one end by any means of attaching, such as by screws or bolts. The other end of the right half and left half of the mounting bracket 104 are spaced apart from one another in a substantially parallel arrangement (see FIG. 2).

The mounting bracket 104 can be made from any desirable and suitable material, such as ¼ inch, 304 stainless steel, which provides for strength and high resistance to corrosion.

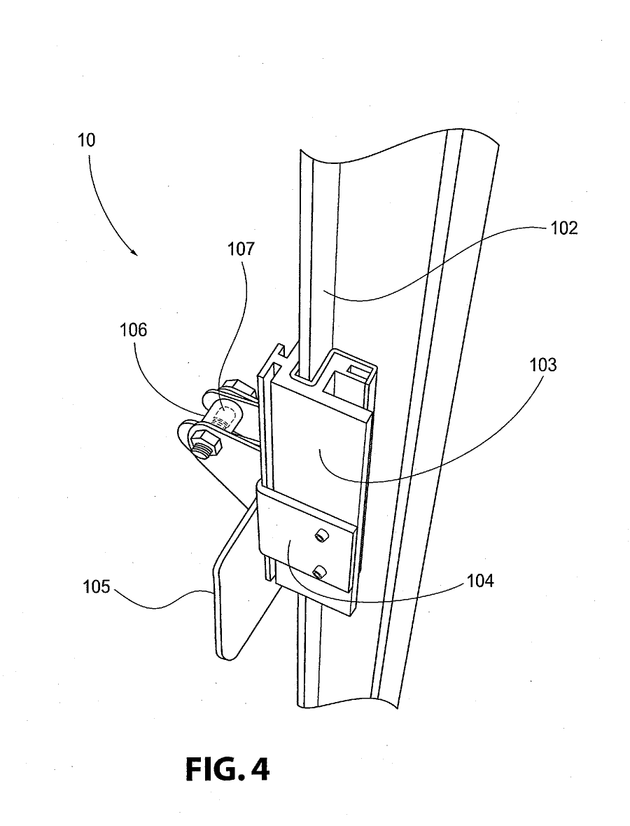

The mounting bracket 104 also includes at least one through-hole 109. In some aspects of the invention, such as FIG. 1, the through-hole is an elongated slot. In other aspects of the invention, the through-hole 109 is only big enough to fit one fastener, such as a nut and bolt arrangement (see, e.g., FIG. 4 in which the boat lift pin 107 attaches the mounting bracket 104 to the boat lift bracket 105). The through-hole 109 is located in the mounting bracket 104 opposite the end attached to the carriage 103. In some aspects of the invention, the length of the through-hole 109 is adjustable. FIG. 1 shows one aspect where the through-hole 109 can be adjusted using at least one bolt-nut-washer assembly 108. FIG. 1 shows an arrangement that uses two bolt-nut-washer assemblies 108 to adjust the length of the through-hole 109. To adjust the length of the through-hole 109, the bolt-nut-washer assemblies 108 are first loosened. The bolt-nut-washer assemblies 108 are then slid along the slot to either lengthen or shorten the opening of the slot of the through-hole 109 between the bolt-nut-washer assemblies 108. Once the desired length of the through-hole 109 is selected, the bolt-nut-washer assemblies 108 are re-tightened.

The boat lift bracket 105 is attached on one end to the mounting bracket 104. The boat lift bracket 105 is used to attach the boat lift stabilizer 10 to the lift 111 (see FIG. 8). The boat lift bracket 105 can be made from any desirable and suitable material, such as ¼ inch, 304 stainless steel, which provides for strength and high resistance to corrosion. The boat lift bracket 105 includes a right half and a left half, connected by a boat lift pin 107. The distance between the right half and left half of the lift bracket connected by the boat lift pin 107 varies based on the desired design. For instance, comparing FIG. 1 and FIG. 2, the right half and left half of the boat lift bracket 105 are distanced nearly by the length of the boat lift pin 107 in FIG. 1, whereas, in FIG. 2, the halves of the boat lift bracket 105 are in contact, or very nearly in contact. An arrangement in between that shown in FIG. 1 and FIG. 2 is also contemplated by this disclosure. The boat lift pin 107 of the boat lift bracket 105 is used to connect the right half of the boat lift bracket 105 and the left half of the boat lift bracket 105. The boat lift pin 107 is, for example, a nut and bolt configuration, but any means suitable to hold the boat lift bracket 105 halves together is contemplated. In some aspects of the invention, such as FIG. 1 and FIG. 4, a spacer element 106 slides over the boat lift pin 107 (before the boat lift pin 107 is used to connect the halves of the boat lift bracket 105) to more rigidly fix the space between the right half of the boat lift bracket 105 and the left half of the boat lift bracket 105 at a set distance apart. In some aspects of the invention, the boat lift pin 107 is configured so as to move laterally in the at least one through-hole 109, such as in a front to back or right to left direction, or both.

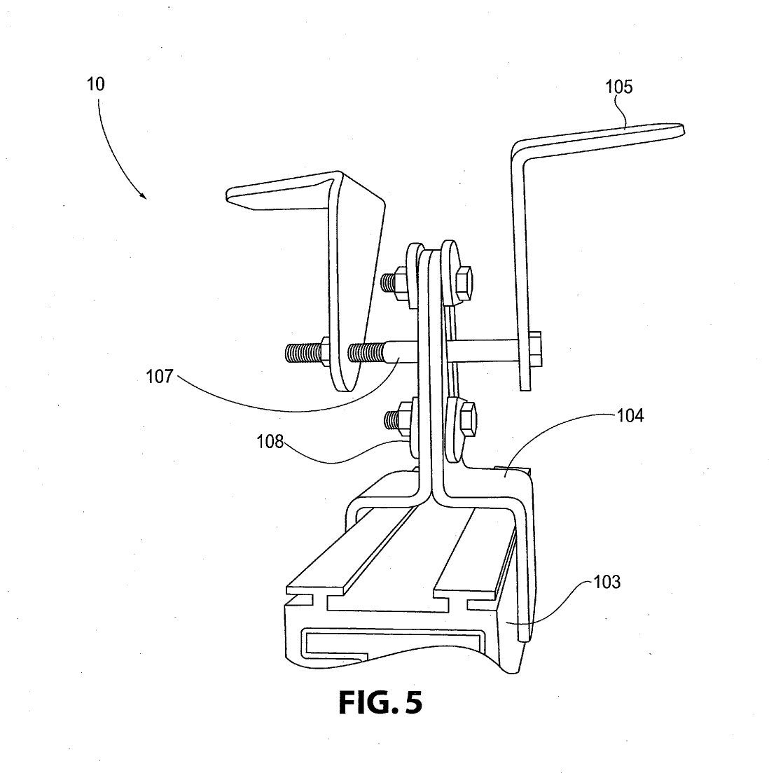

In one aspect of the invention, the boat lift bracket 105 is attached to the mounting bracket 104 by inserting the boat lift pin 107 through the at least one through-hole 109 of the mounting bracket 104. There are at least several arrangements by which the boat lift bracket 105 and mounting bracket 104 are connected using the boat lift pin 107. For instance, as shown in FIGS. 1 and 5, the boat lift pin 107 is inserted into the through-hole 109, which is configured as an elongated slot. In this aspect, the through-hole 109 includes bolt-nut-washer assemblies 108, which, as previously described, are adjusted based on the desired amount of lateral movement. The bolt-nut-washer assemblies 108 shown in FIGS. 1 and 5 are used to restrict the amount of lateral movement of the boat lift pin 107. They are also used to adjust the distance of the boat lift bracket 105 from the support element 102, either moving it closer to or farther from the support element 102 along the elongated slot of the through-hole 109 of the mounting bracket 104.

In another instance using the boat lift pin 107, an arrangement shown in FIGS. 2 and 8 has a boat lift pin 107 inserted into the through-hole 109, which is configured as an elongated slot. In this aspect, the through-hole 109 does not include bolt-nut-washer assemblies 108. Instead, the boat lift pin 107 is configured as a bolt and nut arrangement that is tightened to hold the boat lift pin 107 in its place in the through-hole 109. This arrangement also allows the distance between the boat lift bracket 105 and the support element 102 to be varied along the length of the elongated slot of the through-hole 109. This is done by loosening the bolt and nut arrangement of the boat lift pin 107 and laterally sliding the bolt lift pin 107 along the elongated slot of the through-hole 109 to the desired position. The bolt and nut arrangement of the boat lift pin 107 is then re-tightened.

In another instance using the boat lift pin 107, an arrangement shown in FIG. 4 has a boat lift pin 107 inserted into the through-hole 109 (not visible in the drawing), where the through-hole 109 is not an elongated slot but merely big enough for the boat lift pin 107 in a bolt and nut arrangement. This aspect prevents lateral movement between the boat lift bracket 105 and mounting bracket 104.

In alternative aspects, the boat lift bracket 105 is attached to the mounting bracket 104 through other suitable means (i.e. without a boat lift pin 107 and through-hole 109 arrangement). For instance, the mounting bracket 104 may be welded to the boat lift bracket 105, fixed by other mechanical means such as rivets or nuts and bolts, or by being integrally formed with the mounting bracket such as being an integral extruded piece.

When the connection between the boat lift bracket 105 and the mounting bracket 104 uses the boat lift pin 107 and through-hole 109 arrangement previously described, and when the through-hole 109 is configured as an elongated slot, there may be some lateral movement in the event that it is necessary to accommodate, for example, imperfect lineups or to allow for flexibility in installation of the lift 111. As previously described, the through-hole 109 is adjustable in some aspects of the invention. For instance, as shown in FIG. 1, the bolt-nut-washer assemblies 108 of the through-hole 109 are tightened at a set distance apart from one another to allow for the desired amount of lateral movement. One aspect of the design allows for movement of the boat lift pin 107 in the through-hole 109 on the order of ⅛ inch and up to 2-6 inches if so needed. Alternatively, the bolt-nut-washer assemblies 108 can be adjusted to allow no, or as little as possible, lateral movement. In some aspects, the bolt-nut-washer assemblies 108 are set by either the manufacturer or retailer prior to installation, or by the end user. In some aspects, some allowable lateral movement provides flexibility as the lift 111 moves vertically to allow the lift 111 and/or the vessel to settle in an optimal position. This may also prevent cables associated with the lift 111 from coiling or getting tangled during the operation of the lift 111.

In some embodiments, the user may lock a nut and bolt arrangement of the boat lift stabilizer 10 in place to prevent any movement of the lift 111 once the lift 111 is in its desired position.

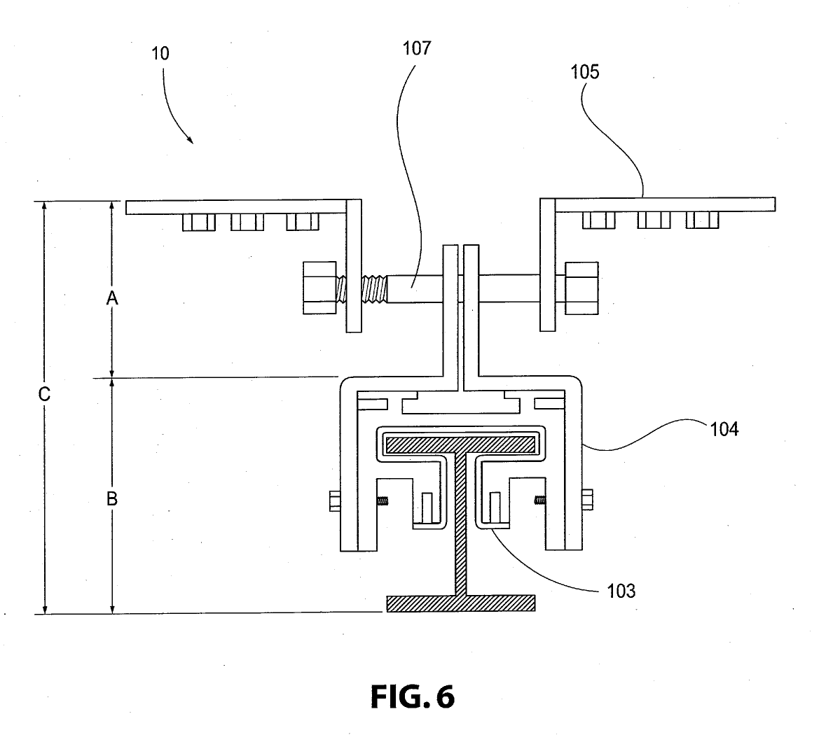

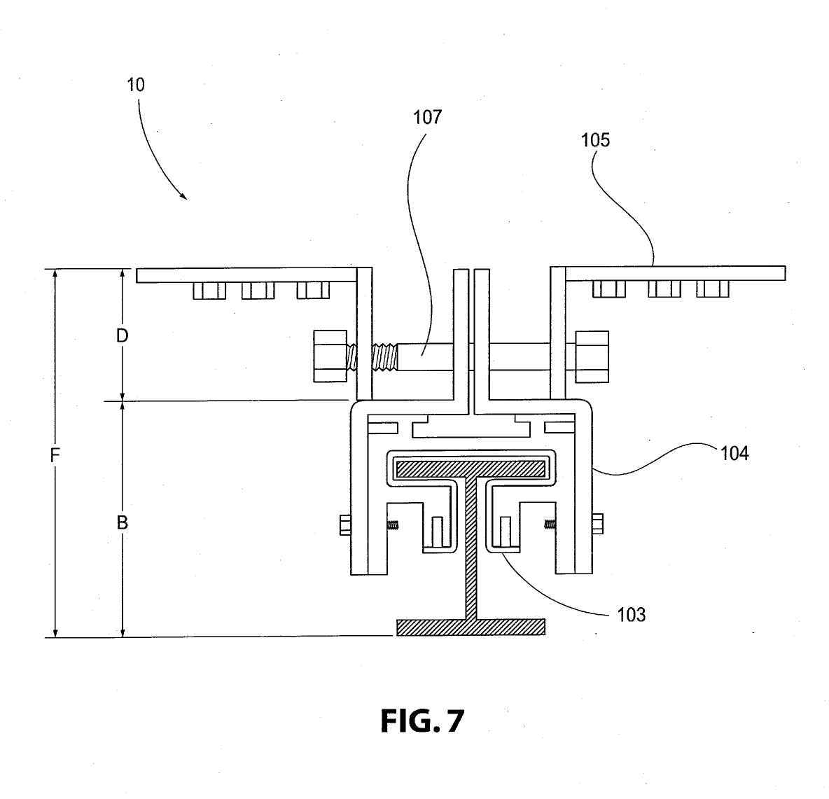

As previously mentioned, in some aspects, the distance between the boat lift bracket 105 and support element 102 is adjustable. For instance, referring to FIGS. 6-7, the boat stabilizer 10 has adjustable dimensions between the boat lift bracket 105, the mounting bracket 104, and the support element 102. In FIG. 6, dimension A corresponds to the distance between a front end of the boat lift bracket 105 and a back end of the mounting bracket 104. Dimension B represents the distance between the back of the mount bracket 104 and a back end of the support element 102. In the example shown in FIG. 6, dimensions A and B are 3 1/16 inches and 4 1/16 inches, respectively. Dimension C corresponds to the entire depth of the mounting bracket 104, boat lift bracket 105, and support element 102, which is 7 ⅛ inches in FIG. 6. FIG. 7, depicts another aspect of the boat lift stabilizer 10 having the boat lift pin 107 in a different position in the through-hole 109 of the mounting bracket 104, so as to position the boat lift bracket 105 closer to the mounting bracket 104, which, in turn, creates a more rigid boat lift stabilizer 10. Dimension D corresponds to the distance between the front end of the boat lift bracket 105 and the back end of the mounting bracket 104, which in FIG. 7 is 2 5/16 inches. Dimension B is the distance between the back end of the mounting bracket 104 and the back edge of the support element 102 and is 4 1/16 inches in FIG. 7. Dimension F corresponds to the entire depth of the mounting bracket 104, boat lift bracket 105, and support element 102 in FIG. 7 and is 6 ⅜ inches in that example.

Referring to FIG. 8, the boat lift bracket 105 is attached to the lift 111. The boat lift bracket 105 is attached to the boat lift 111 by any means that securely fastens the boat lift bracket 105 to the boat lift 111 so that the boat lift stabilizer 10 is able to move vertically as the lift 111 moves vertically. For instance, in FIG. 8, the boat lift bracket 105 is attached to the lift 111 using bolts.

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

What is claimed is:

1. A boat lift stabilizer comprising:
a carriage engaged with a support element in a slideable configuration for movement along the support element, wherein the support element is attached to a structural support member; and
a mounting bracket attached to the carriage on one end and attached to a boat lift bracket on an other end, wherein the boat lift bracket is configured to attach to a lift.

2. The boat lift stabilizer of claim 1, wherein the mounting bracket comprises at least one through-hole, wherein the through-hole is configured to receive a boat lift pin.

3. The boat lift stabilizer of claim 2, wherein the size of the at least one through-hole is adjustable, such that the lateral movement of the boat lift pin in the through-hole is limited to a predetermined amount.

4. The boat lift stabilizer of claim 2, wherein the boat lift pin is insertable through at least one through-hole to attach the boat lift bracket to the mounting bracket.

5. The boat lift stabilizer of claim 4, wherein the size of the at least one through hole is adjustable by at least one bolt-nut-washer assembly to allow lateral movement of the boat lift pin to be from ⅛ inch to 6 inches.

6. The boat lift stabilizer of claim 4, wherein the boat lift pin is inserted through the through-hole and is prevented from any lateral movement.

7. The boat lift stabilizer of claim 2, wherein the mounting bracket comprises a right half and a left half, the right half and left half are each attached to the carriage on one end and are each in physical contact with the other half on an other end.

8. The boat lift stabilizer of claim 2, wherein the mounting bracket comprises a right half and a left half, the right half and left half are each attached to the carriage on one end and are spaced apart from the other half on an other end.

9. The boat lift stabilizer of claim 2, wherein the boat lift bracket has a right half and a left half, wherein a spacer element fixes a space between the right half and the left half of the boat lift bracket.

10. The boat lift stabilizer of claim 1, wherein the carriage is engaged in the slidable configuration using at least one bearing, rolling bearings, or wheels.

11. The boat lift stabilizer of claim 1, wherein the carriage is engaged in the slidable configuration using low friction surfaces or lubricants.

12. The boat lift stabilizer of claim 1, wherein the mounting bracket is welded to the boat lift bracket.

13. The boat lift stabilizer of claim 1, wherein the support element is an I-Beam.

14. A method for stabilizing a vessel comprising:
providing a boat lift stabilizer that comprises:
a carriage engaged with a support element in a slideable configuration for movement along the support element, wherein the support element is attached to a structural support member; and
attaching the boat lift stabilizer to a lift configured to raise or lower a vessel, and when raising or lowering the lift in a vertical direction, sliding the carriage along the support element.

15. The method of claim 14, wherein the boat lift stabilizer limits lateral movement of the vessel.

16. The method of claim 15, wherein the boat lift stabilizer limits lateral movement of the vessel by configuring attachment of the lift and the boat lift stabilizer such that the boat lift is limited in its lateral movement to a predetermined amount.

17. The method of claim 15, further comprising limiting lateral movement of the vessel by further providing a mounting bracket that comprises at least one through-hole that is configured to receive a boat lift pin.

18. The method of claim 17, wherein the boat lift pin is insertable through at least one through-hole to attach a boat lift bracket to the mounting bracket.

19. The method of claim 15, further comprising limiting lateral movement of the boat lift by further attaching a mounting bracket to the carriage, and welding the mounting bracket to boat lift bracket attached to the lift.

20. A system for stabilizing a vessel comprising:
a lift configured to raise or lower a vessel;
a boat lift stabilizer that comprises:
a carriage engaged with a support element in a slideable configuration for movement along the support element, wherein the support element is attached to a structural support member; and
a mounting bracket attached to the carriage on one end and attached to a boat lift bracket on an other end, wherein the boat lift bracket is configured to attach to the lift and prevent or limit lateral movement of the vessel.
